(19) United States
(12) Patent Application Publication
(10) Pub. No.: US 2014/0068005 A1
(43) Pub. Date: Mar. 6, 2014

(54) IDENTIFICATION, CACHING, AND DISTRIBUTION OF REVISED FILES IN A CONTENT DELIVERY NETWORK

(71) Applicant: Zachary David Rosenfield, Seattle, WA (US)

(72) Inventor: Zachary David Rosenfield, Seattle, WA (US)

(73) Assignee: Microsoft Corporation, Redmond, WA (US)

(21) Appl. No.: 13/600,251

(22) Filed: Aug. 31, 2012

(51) Int. Cl. G06F 15/16

(52) U.S. Cl. 709/219

(57) ABSTRACT

A client computer sends a request for a web page to a web site host computer. The host returns an initial web page document that contains a listing of files needed to generate the web page and a revision identifier (RevID) for certain files. The RevID may be a checksum. The client then requests files that do not have a RevID from the host and requests files which do have a RevID from a content delivery network (CDN) server. The host sends the requested files to the client. If the CDN server has the files having the specified RevID it sends those files to the client. If the CDN server does not have a file having the specified RevID it requests that file from another CDN server or the host, which sends that file to the requesting server. The CDN server then sends that file to the client.

### BACKGROUND

When a user at a client computer enters a website address, or clicks on a link in a web page or an email message, the client computer may request all of the files for the web page directly from a host computer. This, however, may cause a slow or unsatisfactory response, especially if the user is at some distance from the host computer, the files are large, and/or there is great demand for the files. In addition, sending large files again and again, over long distances, increases the cost of service for the host company providing the website.

Alternatively, there may be a plurality of servers in a content delivery network (CDN). These servers are geographically distributed to reduce the distance that frequently-used files must be transferred. For example, one CDN server may serve client computers in the New York city area, another CDN server may serve client computers in the Atlanta, Ga. area, another CDN server may serve client computers in the Seattle, Wash. area, and another CDN server may serve client computers in a particular state, region of a state, region of a country, or even an entire country, depending upon the number of client computers and file transfer traffic.

In a CDN environment, the client computer requests the files for the web page from the host computer and the host computer sends an initial web page document to the client computer. This web page document typically specifies two types of files: “dynamic” files, which generally are to be obtained directly from the host, and which may be specific to the individual user, such as an email message; and “static” files, which generally are to be obtained from a nearby server in a content delivery network (CDN), and which are generally frequently used but are not specific to the individual user, such as static graphics, text, or video files. This relieves the host computer of the burden of sending the same file numerous times to numerous users, thereby speeding up the web page generation process and reducing Internet connection costs to the host company.

Many hosts operate in multi-tenant environments where the host provides computer hosting services to more than one company. For example, a single host could provide computer hosting services to one or more search engine companies, social website companies, manufacturing companies, travel companies, hardware companies, charitable organizations, etc. The web pages of each of these companies and organizations will be different, but may use some of the same files. Problems may occur, however, when a file for a web page for one company is modified to provide some benefit or feature desired by that company. That modified file may have the same name as the original file but may, or may not, work with the web pages of the other companies. When this happens the results are often unexpected and unpredictable, and may result in the complete inability to generate the desired web page. This may be confusing and frustrating to a user of the client computer that requested the page.

### SUMMARY

A file has a unique revision identifier (ID) which can be automatically generated, such as, but not limited to, a checksum value. A computer, such as but not limited to a client computer, requests a web page and receives an initial web page document which specifies the files that are needed to generate a requested web page by listing the file names and also lists a revision ID for at least one of the files. For convenience of illustration, and not by way of limitation, the requesting computer is referred to herein as the “client computer”.

Upon receiving the initial web page document, the client computer inspects its own cache of stored files to determine which of the necessary files are already available, and whether any cached file has the specified revision ID. If so, then that cached file can be used. If not, then the client computer requests the file having the specified revision ID from the local CDN server. If the CDN server has the file with that specified revision ID, then the CDN server sends the file to the client computer.

If the CDN server does not have the file having the specified revision ID then the CDN server requests that file from another CDN server or a host computer, which then sends that file with that specified revision ID to the CDN server. The CDN server then sends that file to the client computer. The CDN server also stores the file having the specified revision ID. Then, when another client computer serviced by that CDN server requests that file with that specified revision from that CDN server, that file is now already available on that local CDN server and can be immediately provided to that other client computer, thus speeding up the process of the file delivery and reducing the workload on the host computer and the network.

It should be appreciated that the subject matter described herein may be implemented as a computer-controlled apparatus, a computer process, a computing system, or as an article of manufacture such as a computer-readable storage medium. These and various other features will be apparent from a reading of the following Detailed Description and a review of the associated drawing.

This Summary is a brief and/or simplified introduction to some of the concepts that are described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram illustrating an exemplary environment wherein one or more client computers are connected via a communications medium, such as the Internet, to one or more CDN servers and one or more host computers.

FIG. 2 is a timing diagram showing an exemplary operational timeline for communications between a client computer, a CDN server, and host computer.

FIGS. 3A-3B are flow diagrams showing an exemplary procedure illustrating the operation of a client computer.

FIG. 4 is a flow diagram showing an exemplary procedure illustrating the operation of a content delivery network server.

FIG. 5 is a flow diagram showing an exemplary procedure illustrating the operation of a host computer.

FIG. 6 is a computer architecture diagram illustrating an exemplary computer architecture for devices capable of executing the procedures described herein.

### DETAILED DESCRIPTION

The following detailed description is directed to concepts and technologies for distributing content by way of a CDN network. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawing, in which like numerals represent like elements throughout the several figures, aspects of a computing system, computer-readable storage medium, and computer-implemented methodology for content distribution in a CDN network will be presented.

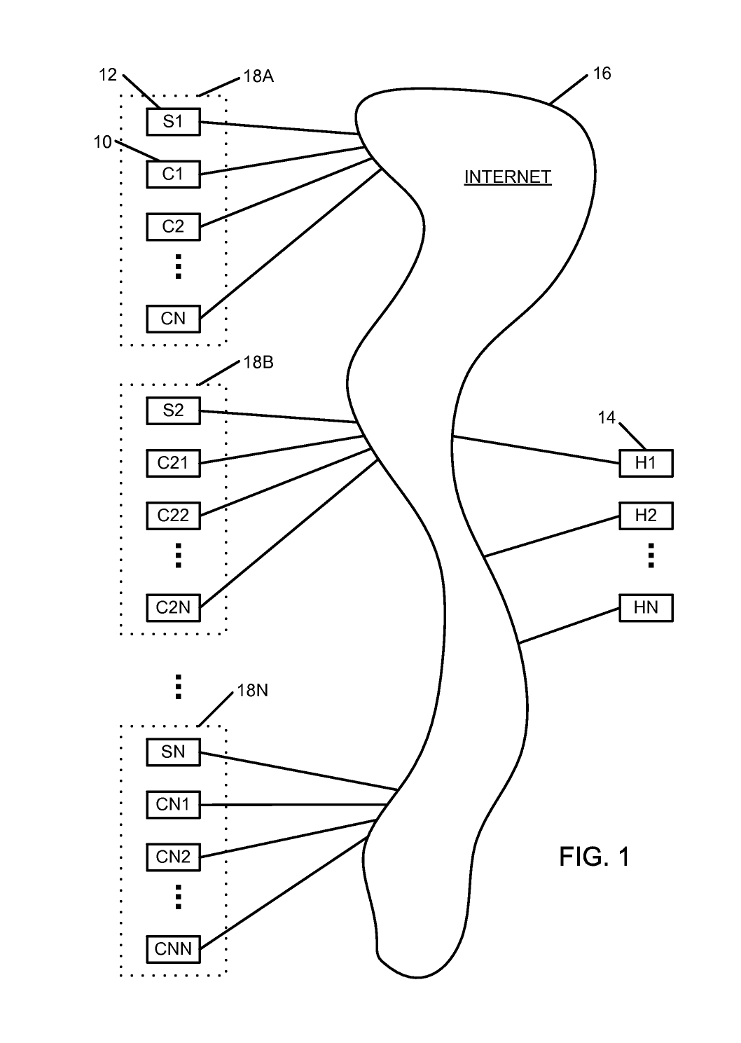

FIG. 1 illustrates an exemplary environment wherein one or more client computers C1, C2, CN, C21, C22 . . . CNN, generally designated by the reference numeral 10, one or more CDN servers S1, S2 . . . SN, generally designated by the reference numeral 12, and one or more host computers H1, H2 . . . HN, generally designated by the reference numeral 14, are connected to a communications medium 16, such as but not limited to the Internet. A client computer 10 may be any type of computing platform, for example, a personal computer, a business computer, a tablet, or another type of computing device that hosts one or more programs. A CDN server 12 is also a type of computing platform but, in this case, stores files for the generation of a web page, and can obtain and store additional such files as desired or needed. A host 14 is also a type of computing platform but, in this case, stores files for the generation of a web page, generally, but not limited to, files used by the host company for the web pages of its tenants.

The communications medium 16 may be, for example, the Internet, a Wi-Fi® connection, some other communications medium, or a combination of one or more these, which provide the capability of transferring files from one point to another. The term “files” is used broadly herein to cover, for example, but not limited to, documents, pictures, email messages, JavaScript™ files, applications, software, plug-ins, cascading style sheets (CSS), master page templates, aspx pages, videos, etc.

Generally, a CDN server 12 will serve client computers 10 within a specified geographic area, such as part of a city, an entire city, a county, part of a state, an entire state, part of a country, an entire country, or even a group of countries, depending upon the number of client computers needing service, the bandwidth of the communications media in that area, etc. For convenience, and not as a limitation, client computers C1-CN are shown as being in geographic area 18A and serviced by a first CDN server (or bank of servers) S1. Similarly, client computers C21-C2N are shown as being in geographic area 18B and serviced by another CDN server (or bank of servers) S2, and client computers CN1-CNN are shown as being in geographic area 18N and serviced by another CDN server (or bank of servers) SN. Preferably, the CDN servers 12 can communicate with each other, as well as with the hosts 14, over the network 16.

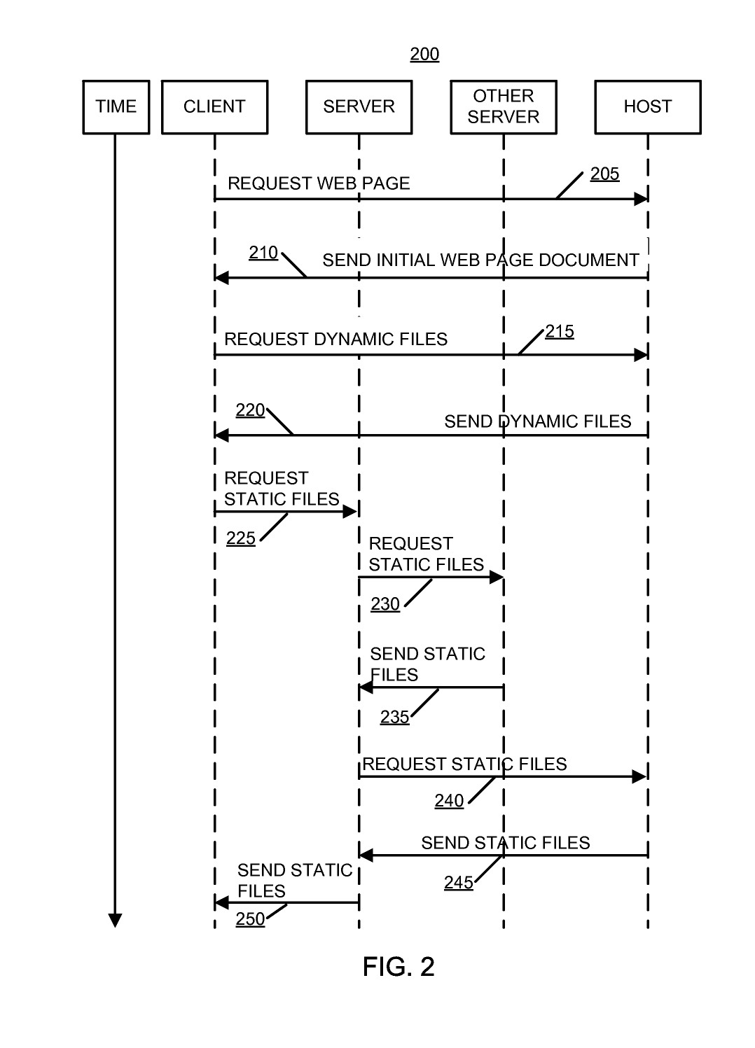

FIG. 2 illustrates an exemplary operational timeline 200 for communications between a client computer 10, a CDN server 12, and host computer 14. The client computer 10, in response to an instruction from a user, requests 205 a web page from the host computer. In response, the host computer sends 210 an initial web page document. Typically, a web page comprises numerous static and dynamic files and the initial web page document lists those static and dynamic files, and also lists a revision ID number for the static files. The initial web page document may also have other information, such as but not limited to instructions as to how the different files are to be arranged to generate the web page. The client computer, in response to receiving the initial web page document, requests 215 the listed dynamic files from the host computer (or even a different host computer). The host computer, in response, sends 220 the requested dynamic files to the client computer.

Either before or after requesting the dynamic files, the client computer inspects its own cache of static files for the listed static files. If a listed static file is found then the client computer compares the revision ID of its cached file with the specified revision ID of the listed dynamic file. If the listed static file is found, and if the revision ID of its cached file does match, then the client computer has the files it needs to generate the requested web page.

If the listed static file is not found, or if the revision ID of its cached file does not match, then the client computer requests 225 the specified static file which has the specified revision ID from the CDN server. The CDN server then inspects its file storage memory for the specified static file that has the specified revision ID. Preferably, but not necessarily, the CDN server inspects its volatile memory first and, if the file is not found, the CDN server then inspects its non-volatile file storage memory, such as but not limited to disk storage. If a listed static file is found then the CDN server compares the revision ID of the stored file with the specified revision ID of the listed dynamic file.

If the listed static file is found, and if the revision ID of the stored file does match, the CDN server then sends 240 the requested static file, which has the specified revision ID, to the client computer for use in generating the requested web page. If the listed static file is not found, or if the revision ID of its cached file does not match, then the CDN server preferably simultaneously requests the 230, 240 the specified file which has the specified revision ID from several other CDN servers and the host computer, which assures that the requesting CDN will get the specified file. The other CDN servers from which the specified file is requested are preferably other servers which are nearby and/or which have a high bandwidth connection. In response to the request from the CDN server, each of those other CDN servers and the host will inspect its file storage memory to locate the specified file which has the specified revision ID and then send 235, 240 that file to the requesting CDN server. The requesting CDN server may receive the specified file from one or more of those other CDN servers and will also receive the specified file from the host computer. Upon receiving the first response returning the specified file, from either another CDN server or from the host computer, the requesting CDN server will send 250 to the client computer the requested file that it receives from any source. This provides the quickest response time to the customer. Subsequent responses from other CDN servers or the host computer may be ignored. This process is performed for each file. It will be appreciated that the requesting CDN server need not wait until it has received a first specified file before it requests a second specified file; the second file may be requested immediately after the first file has been requested or, if parallel communication paths are available, simultaneously send requests for different files.

In an alternative embodiment, if the listed static file is not found, or if the revision ID of its cached file does not match, then the CDN server requests the 230 the specified file which has the specified revision ID from another CDN server, preferably but not necessarily the nearest other CDN server. The file is first requested from the nearest other CDN server so as to minimize the burden on network resources. For example, a CDN server in Olympia, Wash. needing a file might first try to obtain that file from a CDN server in Seattle, Wash. before trying to obtain that file from a CDN server in Dallas, Tex. In response to the request from the CDN server, the other CDN server will inspect its file storage memory to locate the specified file which has the specified revision ID and send 235 that file to the CDN server. If that other CDN server does not have the requested file, or only has some of the requested files, then the CDN server requests 230 the file from another CDN server, such as the next nearest CDN server, and so on. If all of the files cannot be obtained from the other CDN servers, or after the file has been unsuccessfully requested from a predetermined number of other CDN servers, then any missing file will be requested 240 from the host computer. In response, the host computer will inspect its file storage memory to locate the specified file which has the specified revision ID and send 245 that file to the CDN server. The CDN server then stores that file with that revision ID in its file storage memory. The CDN server then sends 250 the requested file, which has the specified revision ID, to the client computer for use in generating the requested web page. This serial request process may provide the same response time as above if the first other CDN server has and returns the requested file. This serial request process may be slower than the simultaneous request process discussed above if the first other CDN server does not have the requested file and the requesting CDN server has to request the specified file from a second or third other CDN server or, eventually, the host computer. This serial request process, however, generally uses less bandwidth and fewer other CDN server and host resources than the simultaneous request process discussed above. This process is performed for each file.

The revision ID is not concerned with whether a file is a current, later, or earlier version of another like-named file; the revision ID is concerned with, and provides an automatic method of determining, whether two or more files are identical, not just whether they have the same name. First consider for example, a file having the exemplary name “core.js”. Later, a developer modifies it for use on a particular web page (or other application) but forgets to note that it has been revised. The modified file will have the same name as the original file, but may provide completely different results and/or not operate in an environment needing the original file. Thus, a user receiving the modified file may have an unsatisfactory experience when visiting a web site that requires the original version. Likewise, if the user's computer detects that it already has a copy of the file, but it has the original version when the modified version is what is needed, then that user may have an unsatisfactory experience when visiting a web site that requires the modified version.

Also, consider the situation wherein the developer does rename the file as “core.js, v1”, but a second developer independently modifies the original file for use on another web page and, not knowing that the first developer has already created a “core.js, v1”, the second developer also names this differently-modified file as “core.js, v1”. The two modified files will have the same name, but may provide completely different results, and/or one modified file may not operate in an environment needing the other modified file.

To avoid these renaming problems, and to be able to distinguish one version of a file from another version of a file, the revision ID for a file is preferably the checksum value for that file. This has significant benefits. Determining the checksum is an automatic procedure, and the checksum will be the same for identical files, but will be different if even one bit is different between two otherwise identical files. Thus, one does not have to be concerned with whether a developer remembered to add a revision number to a modified file, or whether two different developers have made two different modifications but used the same revision number. Further, any client computer, server or host can generate the checksum for a file any time that the checksum is needed. For example, a host computer can send a new file, without the checksum, to a CDN computer, which can then generate the checksum for that file. Thus, it can be dynamically determined if two files are the same file, without having to actually compare those files or to retrieve a stored checksum value, by simply generating the checksum for each file. If the checksums are the same then the files are the same. The checksum for a file thus does not have to be stored or transferred with the file. The checksum, however, may be stored with or as part of a file if desired, for example, to avoid using CDN server (or host) resources to generate a checksum numerous times for a frequently requested file.

Also, one does not have to download a new copy of the same identical file each time it is referenced. For example, if one website requires “core.js” with a checksum (revision ID) of 123, and the client computer (or server) already has file with that revision ID, then it is not necessary to download another copy of that file. If, however, a website requires “core.js” with a checksum (revision ID) of 456, and the only file on the client computer (or server) has a checksum of 123, then it will necessary to obtain that new file. Preferably, both versions (revision ID=123, and revision ID=456) are kept on the client computer (or server) so that the correct file is already available for the particular website of interest. Some value other than the checksum value may be used for the revision ID, but it is preferred that the value be automatically calculated, be independent of the platform on which it is calculated, be independent of the date or time in which it is calculated, and give a different value if a file is modified. It will be appreciated that the checksum values (e.g., 123, 456) used herein are for convenience of illustration. An actual checksum value is a hash value, for example, 01805fe7528f0d98c595ba97b798717a.

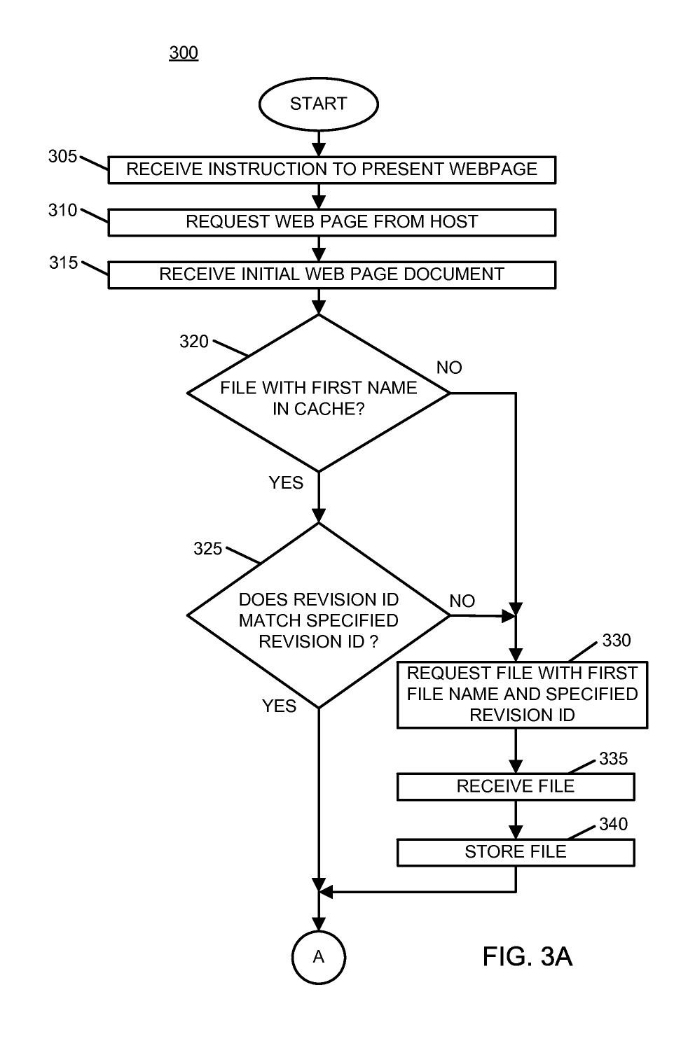

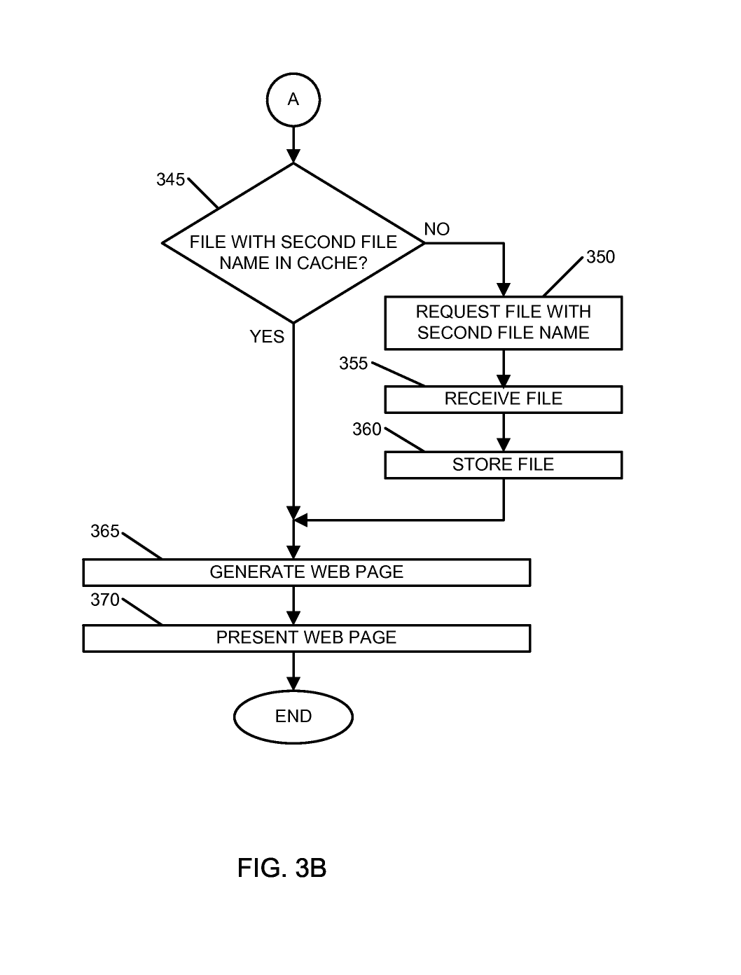

FIGS. 3A-3B are a flowchart of an exemplary procedure 300 illustrating the operation of a client computer 10. The procedure 300 begins at operation 305, where the client computer receives an instruction to obtain a particular web page. The instruction may be, for example, a request by a user of the client computer to go to that web page, or may be by another program, such as a web crawler. The user may have, for example, but not limited to, entered a website address, clicked on a link in a web page, clicked on a link in an email message, given oral instructions, made a movement or gesture which indicated an instruction, or taken some other action to indicate that the user wanted the client computer to obtain and present a web page.

The phrase “obtain a web page” is used in a broad sense herein and includes obtaining the various files needed to generate the web page and storing those files, even if just for a short time. The phrase “present a web page” is also used in a broad sense and includes, for example, visually displaying the web page, generating a sound or sounds or vocalizing the web page, providing tactile feedback to the user, or providing, in some manner, some information about the web page to the user in a form that is meaningful to that particular user.

In response to the instruction, the client computer requests 310 the web page from the host computer. The client computer then receives 315 an initial web page document from the host computer that specifies one or more files having revision IDs, and one or more files that do not have revision IDs. For convenience of discussion and illustration, and not by way of limitation, the procedure 300 only discusses the operations with respect to one of each type of file. If there are two or more of a type of file, then the operations would be performed for each of those files. Also, as there are at least two types of files, for convenience of discussion and not by way of limitation, rather than repeatedly using the phrases “a file which has a revision ID” or “a file which does not have a revision ID”, a file which has a revision ID is sometimes referred to herein as a “file with a first name”, and a file which does not have a revision ID is sometimes referred to herein as a “file with a second name”.

The client computer then begins checking to see if it has the various specified files by determining 320 whether a file with the first name is already in its local cache (or in any other storage location available to the client computer). If a file with the first name is already in its local cache then the client computer inspects 325 the file to determine whether the revision ID of that file matches the specified revision ID. For example, the client computer generates the checksum for the file with the first name and compares that checksum with the specified revision ID. If the revision ID of that file matches the specified revision ID then operation 345 is commenced.

If a file with the first name is not already in its local cache, or if the revision ID of that file does not match the specified revision ID, then the file must be obtained so the client computer then requests 330 a file with the first file name and the specified revision ID from a CDN server, preferably, but not necessarily, a local CDN server. The client computer receives 335 that file from the CDN server and then at least temporarily stores 340 that file. The received file may only be stored while the user is on that particular web page. Preferably, however, the received file is stored in a cache for use with respect to future operations. Operation 345 is then commenced.

At operation 345 the client computer determines whether a file with the second name is already in its local cache (or in any other storage location available to the client computer). If a file with the second name is already in its local cache then operation 365 is commenced. If a file with the second name is not in its local cache then the client computer requests 350 a file with the second file name, preferably but not necessarily from the host computer. The client computer receives 355 that file from the host computer and then at least temporarily stores 360 that file. The received file may only be stored while the user is on that particular web page. Preferably, however, the received file is stored in a cache for use with respect to future operations. Operation 365 is then commenced. Although operations 320-340 are shown as preceding operations 345-360, this is not required. Operations 345-360 could be performed first, followed by operations 320-340.

At operation 365 the client computer renders the web page and then presents 370 the rendered web page to the user. It will be appreciated that if the instruction to obtain the web page comes from another program, such as a web crawler, then the files obtained from the CDN server and/or the host computer may simply be stored, and the web page may not be generated, or the web page may be generated, but not presented.

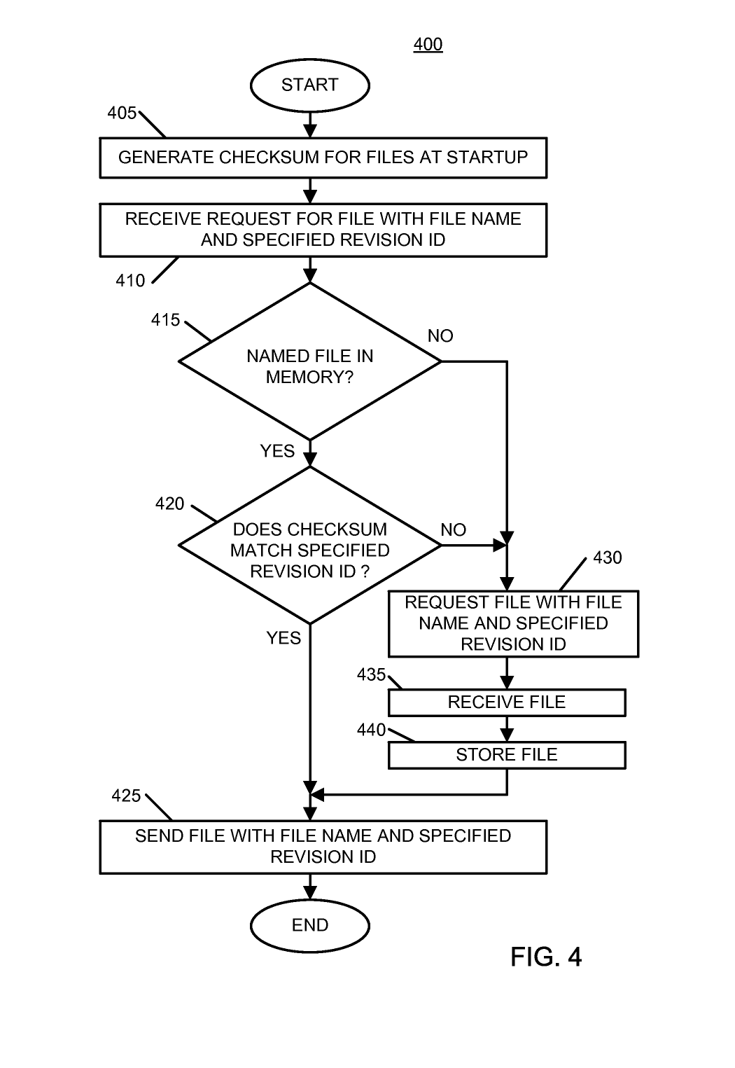

FIG. 4 is a flowchart of an exemplary procedure 400 illustrating the operation of a content delivery network server. A CDN server 12, such as but not limited to server S1, generates a revision ID (checksum value) for each file which may be transferred. Preferably, but not necessarily, these revision IDs are generated 405 when the CDN server starts up (boots up).

At some point, the server will receive 410 a request, such as a request from a client computer, for a file with a file name and having a specified revision ID. As discussed herein, this request may also come from another server but, for convenience of illustration and discussion, it will be presumed that the request came from a client computer. The server then determines 415 whether the named file is already in its local cache (or in any other storage location available to the server). If the named file is already in its local cache then the server inspects 420 the file to determine whether the revision ID of that file matches the specified revision ID. For example, the server generates the checksum for the file and compares that checksum with the specified revision ID. If the revision ID of that file matches the specified revision ID then operation 425 is commenced.

If the named file is not already in its local cache, or if the revision ID of that file does not match the specified revision ID, then the file must be obtained so the server then requests 430 a file with that file name and the specified revision ID simultaneously from the host computer and other servers. The server receives 435 that file from the host computer or another server and then at least temporarily stores 440 that file. Preferably, however, the received file is stored in a long-term cache for use with respect to future requests from users for that web page file. The long-term cache may be periodically cleared of files for which there has been no request for a predetermined period of time, or of files for which the number of requests over a predetermined period of time is less than a predetermined number. Operation 425 is then commenced.

As discussed above, in an alternative embodiment, the server may first request the file from another server before requesting the file from a host, but the operations of the server are essentially the same, regardless of whether the file is being requested from another server or from a host. It is possible that, if a server cannot obtain a desired file from another server, then that server may sequentially request that file from numerous host computers until the file is obtained. It is preferred, however, that if the server cannot obtain the desired file from another server then the server will directly request the file from the originating host. This avoids having to use resources to ask multiple hosts for the file.

Therefore, preferably, when the initial web page is sent from the host computer to the client computer, such as in operation 210 or 315, the information regarding the file will also contain an identification of the responsible host. Preferably, each host has its own, distinct, identification number. Thus, for example, instead of the file information being just “corejs?rev=123”, the file information may be “myhost.com/222/corejs?rev=123”, where “222” identifies the host responsible for that version. The client computer will first look in its own files for “myhost.com/222/corejs?rev=123”. The client computer may also ignore the “myhost.com/222/” part and just look in its own files for “core.js?rev=123”. If the file is not found, then the client computer will send the file information “myhost.com/222/corejs?rev=123” to its affiliated server. The server may ignore the “myhost.com/222/” part and first look in its own files for “corejs?rev=123”. If the file is not found, and is not available from another server, then the server will request the file “corejs?rev=123” from the host having the host identification number “222”. For example, the server may send the request to host 222 as “222.myhost.com/corejs?rev=123”. The host computer may ignore the “222.myhost.com” part and look in its own files for “core.js?rev=123”.

At operation 425 the server sends the requested file, having the specified revision ID, to the client computer. Thus, at this point, the server may have two files with the same name, but they will produce different revision IDs (checksums). It will be appreciated that this process brings files from the host computer to a local CDN where they can be more rapidly and efficiently distributed.

Consider, for example, that a developer modifies a document needed for a web page from the host computer. The host computer will generate a checksum value for that modified file, and the initial web page document will then refer to that file with the new checksum value. Assume now that a first user wishes to view the web page. The first user's client computer will receive the new initial web page document and will request that modified file from the local CDN server. The local CDN server, however, will not have that file so it will request it from the host computer, store that file, and send a copy to the client computer.

Now assume that a second user wishes to view the same web page. The second user's client computer will receive the new initial web page document and will request that modified file from the local CDN server. The local CDN server now has that modified file, having previously obtained it from the host computer in response to the request from the first user. Thus, the local CDN server can immediately send the modified file to the second user's client computer. Therefore, once a first user has requested a file, that file then becomes available on the CDN server for all subsequent requesters of that file, thus speeding up the download process and enhancing the user experience of subsequent users, reducing the amount of Internet traffic which must traverse long distances, and relieving the host computer of the burden of sending the modified file to every new user who requests it.

This also provides benefits for the hosts and tenants as well. Assume that the web page for a large tenant company uses the file “core.js” with a revision ID of 123, and that the web page for a small tenant company uses the same file with the same revision ID for its web page. It is quite likely that the web page of the larger company will be accessed for the first time before the web page for the small company, so the local CDN server will obtain that file from the host computer. It is also quite probable that multiple CDNs will obtain that file because of requests from multiple users for the web page of the larger company. Then, when a user wants to visit the smaller company's website, the local CDN server will already have that file, so the response time will be faster than if the file had to be retrieved from the host computer. This benefit also applies where both companies are large or both companies are small; the first time a file is called for in a CDN service area results in that file being stored in that local CDN, thereby improving the response time for users in that CDN's service area. The host computer for the tenant company's web site where the file is first requested provides the file to a CDN server, and later requests for that file are provided by the CDN server for that area, not by the host computer. This relieves traffic for both the host computers and for the Internet as well.

Preferably, but not necessarily, each local CDN server farm requests and stores files independently of other CDN server farms. Thus, one CDN server, for example, server S1 may have the newly modified file because at least one user has requested a web page which requires it. Another CDN server, for example, server S2, may not have the newly modified file because no user of that CDN server has requested that file. Once, however, a user of that CDN server S2 requests that file, then that file will be available on server S2 for all subsequent requesters. This prevents the CDN servers from having to store files that are not requested by users in that CDN's local area. For example, if a particular file is used only by a small company in one city, then it would not be advantageous for every CDN to store that file as it would likely never be requested by users outside of that local CDN area.

In an alternative embodiment, each CDN server farm will notify at least some other CDN server farms of any newly-modified and -acquired files and, upon request from those other server farms, send a copy of the newly-modified and -acquired file to them. For example, a CDN server farm serving one major city in a state may be associated with CDN server farms serving other major cities in that state, or nearby cities, on the presumption that the users in those areas would be interested in viewing many of the same web pages. In that embodiment, once a first user requests a new file, then everyone who uses any of those associated CDN servers will have faster access to the newly-modified and -acquired file.

In another alternative embodiment, if a CDN server receives a request from another CDN server for a particular file which is used in the web page of large company which has numerous web page requests, then it is quite likely that web page requests which need the new file will appear in many other CDN service areas, so in anticipation of future requests for that file/version, that CDN server may proactively obtain that file/version.

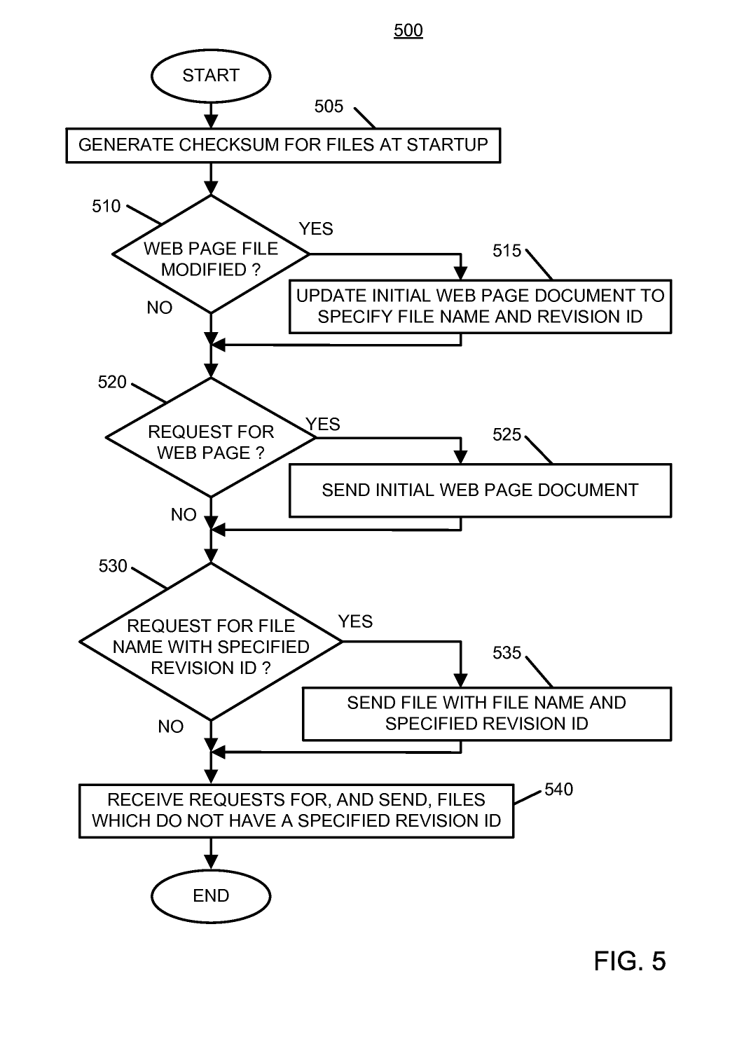

FIG. 5 is a flowchart of an exemplary procedure 500 illustrating the operation of a host computer. A host computer 14, such as but not limited to host computer H1, generates a revision ID (such as a checksum value) for each file which may be transferred. Preferably, but not necessarily, these revision ID values are generated 505 when the host computer starts up (boots up).

The host computer then determines 510 whether a web page file has been modified (or a new web page has been created). If not, operation 520, 530 or 540 may be commenced. If a web page file has been modified (or a new web page has been created) then the initial web page document is updated 515 to specify the information, such as but not necessarily limited to the file name, revision ID of any modified or newly added static files (or to specify the file name and revision ID of the static files for the new web page). This update is then stored. The information for a file preferably also includes an identification of the host computer for this file, for example, host #222 as indicated the example above. Operation 520, 530 or 540 may then be commenced.

The host computer may then determine 520 whether a request for a web page has been received. If not, then another operation, such as operation 530 or 540, may be commenced. If a request for a web page has been received then the initial web page document is sent 525 to the requester.

The host computer may then determine 530 whether a request for a file name with a specified revision ID. If not then another operation, such as operation 520 or 540 may be commenced. If such a request has been received then the requested file having the specified revision ID is sent 535 to the requester. Operation 540 may then be commenced.

In operation 540 the host computer receives requests for, and sends to the requester, files which do not have a specified revision ID, such as dynamic files. The host could then perform other operations such as, for example, operations 520 or 530. Although operations 520-525, 530-535, and 540 are shown in a particular order, this is not required. For example, operation 540 could be performed before those other operations.

Also, although FIG. 5 describes operation primarily with respect to a host computer, operations 530 and 535 also describe the operation of a CDN server which receives a request for a file from another CDN server.

It should be understood that the operations of the exemplary procedures 300, 400 and 500 disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated procedures can be ended at any time and need not be performed in its entirety. Some or all operations of the procedures, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

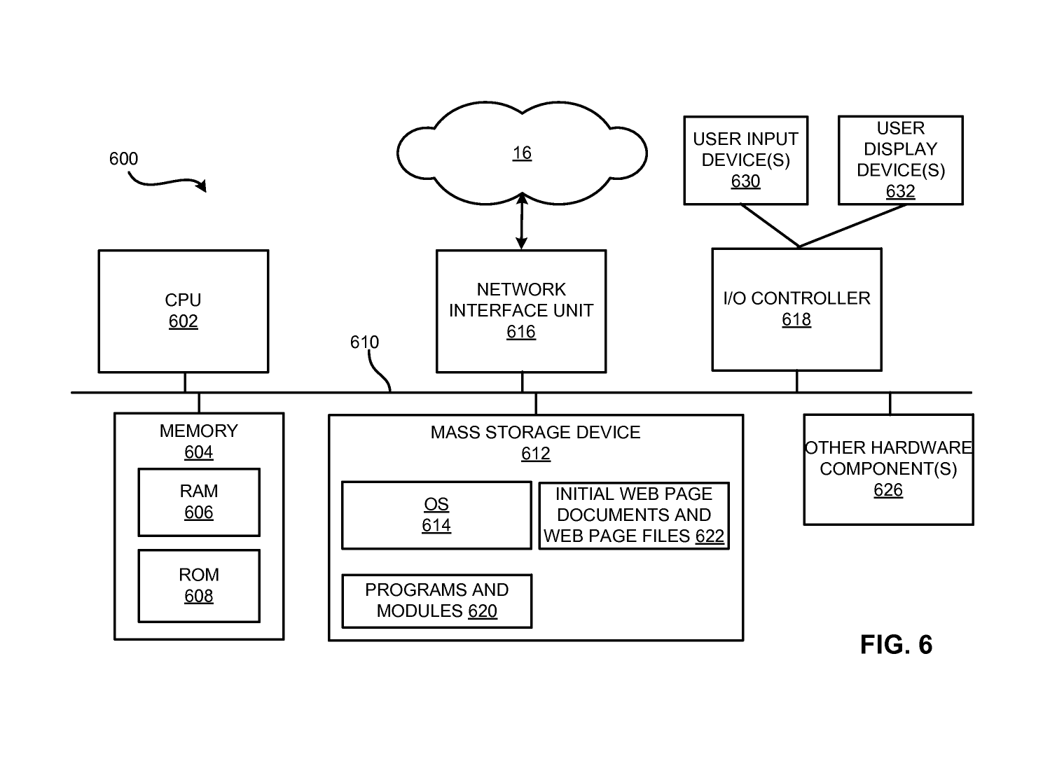

FIG. 6 illustrates exemplary computer architecture 600 for devices 10, 12 and 14 capable of performing as described herein. Thus, the computer architecture 600 illustrates an exemplary architecture for a host computer, a server computer, a mobile phone, a PDA, a smart phone, a desktop computer, a netbook computer, a tablet computer, and/or a laptop computer. The computer architecture 600 may be utilized to execute any aspects of the software operations presented herein.

The exemplary computer architecture 600 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing the operating system 614, the initial web page documents for the various web pages and the various web page files 622, one or more programs or modules 620, such as the modules described above with regard to the operation of the various computing platforms.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or CD-ROM drive, those skilled in the art will appreciate that computer-readable media can be any available computer storage media or communication media that can be accessed by the computer architecture 600.

The initial web page document, and any web page files, may be sent by the processor 602 retrieving these items from the mass storage device 612 and then sending these items via the network interface unit 616, by causing the mass storage device 612 to send these items directly to the network interface unit 616 instead of to the processor 602, or a combination of both, whereby some items are sent directly from the mass storage device 612 to the network interface unit 616, and other items are sent from the processor 602 to the network interface unit 616.

Although the memory 604 and mass storage device 612 are preferably separate components, the memory 604 could be included in a mass storage device 612. The memory 604 and mass storage device 612 may be collectively considered to be, and referred to as, a memory device.

Other hardware components 626 may also be present. For example, a sensor component, such as a magnetometer, an ambient light sensor, a proximity sensor, an accelerometer, a gyroscope, a global positioning system (GPS) sensor, a microphone or other audio input device, a camera, etc. may be present.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of the claims, the phrase “computer storage medium” and variations thereof, do not include waves and transitory signals per se without any associated device for the transmission, reception, detection, processing, or storage of the wave or transitory signal.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above are also included within the scope of computer-readable media.

According to various embodiments, the computer architecture 600 may operate in a networked environment using logical connections to remote computers and/or servers through a network such as the network 16. The computer architecture 600 may connect to the network through a network interface unit 616 connected to the bus 610. The network interface unit 616 also may be utilized to connect to other types of networks and remote computer systems.

The computer architecture 600 also may include an input/output controller 618 for receiving and processing input from one or more user input devices 630 such as, but not limited to, a keyboard, mouse, touchscreen, touchpad, keypad, or electronic stylus. Similarly, the input/output controller 618 may provide output to one or more user display devices 632 such as, but not limited to, a display screen, a printer, or other type of output device. A user input device 630 and a user output device 632 may be embodied in the same component, such as a touch-sensitive screen. The user input device 630 and the user output device 632 may be integral with a device, such as in the case of a handheld device, or may be separate components, such as a keyboard, mouse and display used with many desktop systems.

The software components described herein, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. The CPU 602 may be a single processor, or may be a plurality of processors. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, many types of physical transformations take place in the computer architecture in order to store and execute the software components presented herein. Also, the computer architecture may include other types of computing devices, including hand-held computers, embedded computer systems, personal digital assistants, and other types of computing devices known to those skilled in the art. It is also contemplated that the computer architecture may not include all of the components shown herein, may include other components that are not explicitly shown herein, or may utilize an architecture completely different than that shown herein.

The subject matter described above is provided by way of illustration only and are not to be construed as limiting. Various modifications and changes may be made to the subject matter described herein without following the exemplary embodiments and applications illustrated and described herein. Although the subject matter presented herein has been described in language specific to computer structural features, methodological and transformative acts, specific computing machinery, and computer readable media, it is to be understood that the appended claims are not necessarily limited to the specific features, acts, or media described herein. Rather, the specific features, acts and mediums are disclosed as example forms of implementing the claims.

What is claimed is:

1. A method of operation of a computer, the method comprising:
receiving an instruction to obtain a web page;
sending a first request for the web page;
receiving an initial web page document, the initial web page document comprising a list of files required to generate the requested web page, the list comprising at least a first file name, a second file name, and a specified revision identifier for the first file;
searching a local cache for a file having the first file name and the specified revision identifier;
if a file having the first file name and the specified revision identifier is not present in the local cache then sending a request for a file having the first file name and the specified revision identifier, and receiving the requested file;
searching a local cache for a file having the second file name;
if a file having the second file name is not present in the local cache then sending a request for a file having the second file name, and receiving the requested file; and
at least temporarily storing at least some of the received files.

2. The method of claim 1 and further comprising:
generating the web page using at least the file having the first file name and the specified revision identifier, and the file having the second file name; and
presenting the generated web page.

3. The method of claim 1 wherein searching the local cache for a file having the first file and the specified revision identifier comprises:
searching the local cache for a file having the first file name;
if a file having the first file name is not present in the local cache then sending the request for a file having the first file name and the specified revision identifier;
if a file having the first file name is present in the local cache then determining whether that cached file has the specified revision identifier; and
if that cached file does not have the revision identifier then sending the request for a file having the first file name and the specified revision identifier.

4. The method of claim 3 wherein determining whether that cached file has the specified revision identifier comprises:
comparing a checksum for that cached file with the specified revision identifier;
if the checksum is not the same as the specified revision identifier then sending the second request for a file having the first file name and the specified revision identifier.

5. The method of claim 1, and further comprising caching the received file having the first file name and the specified revision identifier.

6. The method of claim 1, and further comprising caching the received file having the second file name.

7. The method of claim 1 wherein sending and receiving comprises sending over the Internet and receiving over the Internet.

8. A method of operating a server in a content delivery network, comprising:
receiving a first request for a file having a file name and a specified revision identifier;
searching a local memory for a file having said file name and said specified revision identifier;
if a file having said file name and said specified revision identifier is not present in the local memory, then sending a second request for said file having said file name and said specified revision identifier and receiving the requested file having said file name and said specified revision identifier; and
sending the file having said file name and said specified revision identifier in response to the first request.

9. The method of claim 8, wherein searching a local memory for a file having said file name and said specified revision identifier comprises:
searching the local memory for a file having said file name;
if a file having said file name is not present in the local memory then sending the second request;
if a file having said file name is present in the local memory then determining whether said file having said file name has said specified revision identifier; and
if said file in the local memory having said file name does not have said specified revision identifier then sending the second request.

10. The method of claim 9 wherein determining whether said file having said file name has said specified revision identifier comprises:
comparing a checksum for said file having said file name with said specified revision identifier;
if said checksum is not the same as said specified revision identifier then proceeding to sending the second request.

11. The method of claim 10 wherein generating a checksum for said file having said file name is performed as a part of the startup operation of the server.

12. The method of claim 8, and further comprising at least temporarily storing in the local memory the received requested file having said file name and said revision number.

13. The method of claim 8 wherein sending the second request comprises sending, over the Internet, the second request to at least one of another server or to a host, and receiving the requested file comprises receiving, over the Internet, the requested file from the other server or the host.

14. The method of claim 8 and further comprising:
receiving a subsequent request for the file having the file name and the specified revision identifier; and
sending the file having said file name and said specified revision identifier in response to the subsequent request.

15. A server comprising:
a memory device containing operating instructions and files;
a network interface unit;
a processor, communicatively coupled to the memory device and to the network interface unit, the processor executing the operating instructions to:
receive, via the network interface unit, a first request for a file having a file name and a specific revision identifier;
search the memory device for a file having said file name and said specific revision identifier;
if a file having said file name and said specific revision identifier is not present in the local memory then send, via the network interface unit, a second request for said file having said file name and said specific revision number;
receive, via the network interface unit, the requested file having said file name and said specific revision number; and
send, via the network interface unit, the file having said file name and said specific revision number in response to the first request.

16. The server of claim 15 wherein, to search the memory device for a file having said file name and said file having said file name and said specific revision identifier, the processor further executes the operating instructions to:
search the local memory for a file having said file name;
if a file having said file name is not present in the local memory then to send the second request;
if said file having said file name is present in the local memory then to determine whether said file having said file name has said specific revision identifier; and
if said file in the local memory having said file name does not have said specific revision identifier then to send the second request.

17. The server of claim 16 wherein, to determine whether said file having said file name has said specific revision identifier, the processor further executes the operating instructions to:
compare a checksum for said file having said file name with said specific revision identifier;
if said checksum is not the same as said specific revision identifier then to send the second request.

18. The server of claim 17 wherein the processor further executes the operating instructions to generate a checksum for said file having said file name as a part of the startup operation of the server.

19. The server of claim 17 wherein the processor further executes the operating instructions to at least temporarily store in the local memory the received file having said file name and said specific revision number.

20. The server of claim 17 wherein the processor further executes the operating instructions to send by sending, over the Internet, the second request to at least one of another server or to a host, and further executes the operating instructions to receive by receiving, over the Internet, the requested file from the other server or the host.
